(19) United States
(12) Patent Application Publication
(10) Pub. No.: US 2017/0102785 A1
(43) Pub. Date: Apr. 13, 2017

(54) APPARATUS FOR USE WITH AN OPTICAL MOUSE AND MANUFACTURING METHOD THEREOF

(71) Applicant: Microsoft Technology Licensing, LLC, Redmond, WA (US)

(72) Inventor: Wuyang Huang, Beijing (CN)

(21) Appl. No.: 15/289,084

(22) Filed: Oct. 7, 2016

(30) Foreign Application Priority Data
Oct. 8, 2015 (CN) 201510647180.7

(51) Int. Cl. G06F 3/03; G06F 3/038; G06F 3/0354

(52) U.S. Cl. CPC G06F 3/0317; G06F 3/03543; G06F 3/038

(57) ABSTRACT

An apparatus for use with an optical mouse and a method of manufacturing the apparatus are provided. In one embodiment, the apparatus includes a board having a surface operable to be in contact with a window of the optical mouse; and a lifting member operable to move the surface away from the window. In response to a distance between the surface and the window being below or exceeding a predefined threshold, a lateral movement of the surface with respect to the window being detectable or undetectable, respectively, by the optical mouse. The apparatus provides a handy tool to be used by an end user, so that he/she is able to use an existing mouse in the air, and control the cursor by manually operating the board and the lifting member in an intuitive and ergonomic manner.

### CROSS-REFERENCE TO RELATED APPLICATION

This non-provisional utility application claims priority of CN application serial number 201510647180.7 entitled “APPARATUS FOR USE WITH AN OPTICAL MOUSE AND MANUFACTURING METHOD THEREOF” and filed on Oct. 8, 2015, which is incorporated in its entirety by reference.

### BACKGROUND

Conventionally, end users put an optical mouse on a flat surface with its window facing downward, and move the mouse on the surface in order to facilitate the navigation. This operation is intuitive when the computer is used on a desk providing a large enough surface and the end user is well seated in front of the computer. However, in some cases especially when the user wishes to give a presentation, he/she may need to stand far from the computer or walk around in a room. This means that it is no longer possible for the user to use such an optical mouse, because he/she may not find a suitable surface right in front of him/her.

Some existing devices commercially available refer to specially designed mice which may be either expensive or bulky to carry. A simple yet handy apparatus is therefore in need in order to be used with existing mice, particularly optical mice, and it has good usability and applicability, allowing a vast amount of existing mice to be used for navigating in the air.

### SUMMARY

In accordance with implementations of the subject matter described herein, an apparatus for use with an optical mouse is provided. The apparatus includes a board and a lifting member. The board has a surface operable to be in contact with a window of the optical mouse. The lifting member is operable to move the surface away from the window. If a distance between the surface and the window is below a predefined threshold, a lateral movement of the surface with respect to the window is detectable by the optical mouse. Otherwise, the lateral movement is undetectable. Such an apparatus enables a controlling of cursor movements displayed in the screen, namely, a functional navigation of the mouse as if the mouse is used on a desk. In addition, the apparatus allows an intuitive and ergonomics-orientated operation and be compatible to most mice available on the market. By using the example apparatus described herein, a user is able to give a presentation that is more vivid, because he/she no longer needs to stand in the vicinity of a computer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of an apparatus according to one embodiment of the subject matter described herein;

FIG. 2 illustrates a perspective view of the apparatus displaced from the mouse according to one embodiment of the subject matter described herein;

FIG. 3 illustrates another perspective view of the apparatus of FIG. 2;

FIG. 4 illustrates an exploded view of the apparatus according to one embodiment of the subject matter described herein;

FIG. 5 illustrates a sectional side view of the apparatus of FIG. 4 fixed onto an optical mouse, with the board laid against the optical mouse;

FIG. 6 illustrates a sectional side view of the apparatus of FIG. 4 fixed onto an optical mouse, with the board lifted away from the optical mouse;

FIG. 7 illustrates a top view of the apparatus according to one embodiment of the subject matter described herein;

FIG. 8 illustrates a perspective view of the apparatus displaced from the mouse according to another embodiment of the subject matter described herein;

FIG. 9 illustrates a flowchart of a method of manufacturing the apparatus in accordance with embodiments of the subject matter described herein.

### DETAILED DESCRIPTION

The subject matter described herein will now be discussed with reference to several example embodiments. These embodiments are discussed only for the purpose of enabling those skilled persons in the art to better understand the subject matter described herein, rather than suggesting any limitations on the scope of the subject matter.

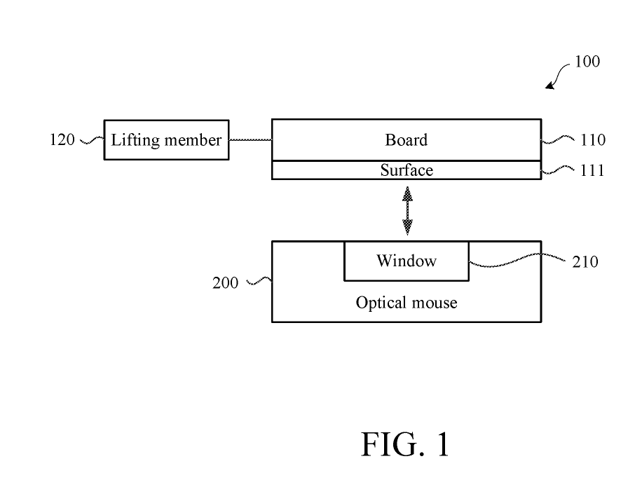

The term “includes” and its variants are to be read as open terms that mean “includes, but is not limited to.” The term “or” is to be read as “and/or” unless the context clearly indicates otherwise. The term “based on” is to be read as “based at least in part on.” The term “one embodiment” and “an embodiment” are to be read as “at least one embodiment.” The term “another embodiment” is to be read as “at least one other embodiment.” Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-9. Other definitions, explicit and implicit, may be included below.

A mouse is an important and popular pointing device to be used with a computer. With various types of devices, users are able to navigate a cursor within a displayed area shown in a screen, so as to click on a link or a virtual button at a particular position in the screen. For example, a traditional mouse incorporates a ball in a cavity. The mouse of this type can be moved on a surface by the end user, making the ball rotates relative to the mouse itself. The rotation of the ball in turn rotates at least one of two bars held within the cavity. As a result, the cursor is moved either in horizontal direction or in vertical direction within the screen. In various embodiments as described herein, the “navigation” refers to an action which controls the mouse in a manual way and accordingly moves the cursor to an intended position.

More recently, optical mice with lighting devices are more and more popular for their ease of use and navigating precision. To track the motion of an optical mouse, a surface is usually required to be put as close as possible to a window of the mouse. Such a window allows the emissions from the light source, such as a laser diode or a LED diode, to hit on the surface. Then, the emissions will be reflected (diffused) by the surface, and eventually captured by a sensor located in the mouse in order to detect a relative movement between the mouse and the surface. With the detected relative movement, the navigation of the optical mouse can be easily achieved.

A conventional mouse has a cord to be connected to a computing device, such as a laptop or a server, in order to send signals associated with the detected movements of the mouse to the computing device, and thus the cursor shown in the screen can be controlled. A wireless mouse usually incorporates a transmitter in its housing for transmitting the signals, by using no cord, to a receiver of the computing device. Such a transmitter may utilize any suitable encoder and protocol to send the signal. There are various wireless mice available on the market. However, although the wireless mouse enables its users to use it from a relatively remote distance, the conventional mouse may incorporate a light-weighted cord that has an extendable length in a large range, and thus can be used from a remote distance as well. These types of mice are widely available, and the embodiments described herein are meant to be used with all these types.

FIG. 1 illustrates a schematic diagram of an apparatus 100 according to one embodiment of the subject matter described herein. The apparatus 100 is described with only for the purpose of illustration without suggesting any limitations as to the scope of the subject matter described herein. Different embodiments with different structures can realize the purpose and concept of the subject matter described herein.

As shown, the apparatus 100 includes a board 110 which has a surface 111 operable to be in contact with a window 210 of an optical mouse 200. The optical mouse 200 is commercially available which utilizes a light source to emit light as well as a sensor to detect the reflected or diffused light, as described above, to track a lateral movement between the optical mouse 200 and the surface 111 in case that the surface 111 is close enough to the window 210. Usually, such a distance between a surface and a window of an optical mouse has to be within a predefined threshold so as to make the reflected or diffused light detectable. In other words, if the board 110 is moved by a predefined threshold away from the window, the lateral movement of the surface 111 with respect to the window 210 is undetectable by the optical mouse 200. For example, a distance exceeding 2 mm makes the lateral movement undetectable by sensors within most mice. In various embodiments as described herein, the “lateral movement” refers to a relative movement between the surface and the window of the mouse without changing the distance from the surface to the window.

A lifting member 120 is also provided which is operable to move the board 110 away from the window 210. In this configuration, when the user would like to navigate the mouse 200, he/she may need to put the board 110 as close as possible to the optical mouse 200 so that the surface 111 is in contact with the window 210. By doing so, the surface 111 is able to reflect the emitted light back to the optical mouse 200 through the window 210. As a result, the lateral movement of the board 110 induced by the user is detectable by the optical mouse 200, which in turn moves the cursor accordingly within the screen. When the surface 111 is moved out of the window 210, the user is able to lift the board 110 away from the optical mouse 200 by the predefined threshold, thus making the lateral movement undetectable. The user may then reposition the board 110 and put it onto the window 210, in order to once again move the cursor that is otherwise not possible to be moved due to the surface 111 being out of range of the window 210.

The board 110 can be moved by a finger to facilitate the lateral movement as described above. In response to the finger lifting away from the window 210 or the optical mouse 200, the board 110 is in turn lifted away from the window 210 or the optical mouse 200 as well. On the other hand, in response to the finger pushing toward the window 210 or the optical mouse 200, the board 110 is in turn laid against the window 210 or the optical mouse 200 as well. In other words, a vertical movement of the board 110 is manually controllable by the user. In various embodiments as described herein, the “vertical movement” refers to a relative movement between the surface and the window of the mouse by shortening or enlarging the distance from the surface to the window. In view of the above, the apparatus 100 allows the user to navigate the existing mouse 200 in the air. For example, the user may hold the mouse 200 upside-down and control the vertical and the lateral movements of the board 110 by his/her thumb.

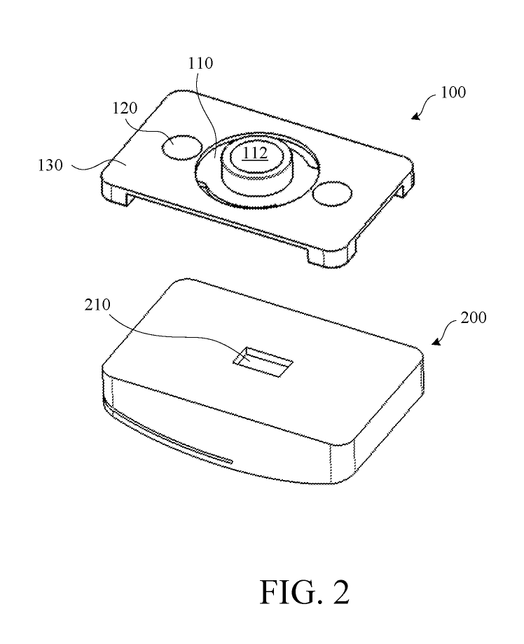

FIG. 2 shows a perspective view of the apparatus 100 displaced from the mouse 200 according to one embodiment of the subject matter described herein. In this embodiment, the apparatus 100 includes a frame 130 that can be fixed to the mouse 200. The frame 130 is able to provide a steady and robust connection with the body of the mouse 200 by means of, for example, a clamping mechanism (not shown), an adhesive member (not shown), etc. The form of such an attachment of the frame 130 to the mouse 200 is not to be limited. Further, the frame 130 is able to be installed to mice with different sizes. For example, in case that the frame 130 is connected with the body of the mouse 200 by means of a clamping mechanism, the clamping mechanism can be adjusted accordingly as the size of the mouse 200 varies to clamp the mouse 200. Also, in case that the frame 130 is connected with the body of the mouse 200 by means of an adhesive, the frame 130 may be attached to the mouse 200 in a suitable position where the surface 111 and the window 210 are well aligned.

A lifting member 120 may be provided on the frame 130. In the absence of external force applied onto the board 110, the lifting member 120 is operable to lift the board 110 away from the window 210 of the mouse 200. A protrusion 112 may be provided on the board 110, allowing to be moved by the user (one of his/her fingers, for example). In one embodiment, the lifting member 120 can keep the board 110 in position with respect to the frame 130 as close as possible, such that when the user does not exert a force onto the board 110 or protrusion 112, the board 110 will be lifted against the frame 130. In other words, only if the board 110 or the protrusion 112 is applied with a force toward the mouse 200, can the board 110 be moved such that the surface 111 is in contact with the window 210.

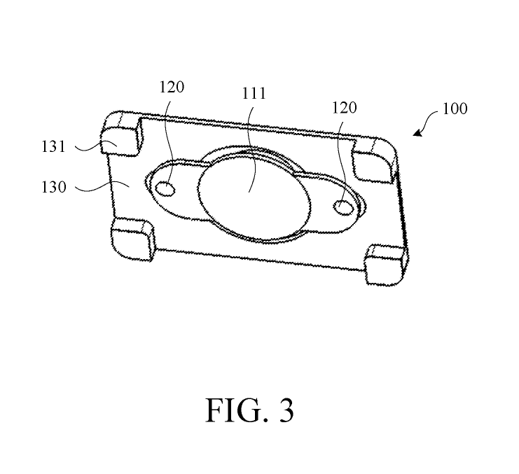

FIG. 3 shows another perspective view of the apparatus 100 of FIG. 2, with the surface 111 visible. In this embodiment, four posts 131 are provided on the frame 130 so as to fix the frame 130 to the mouse 120. As discussed above, the frame 130 can be attached to the mouse 200 by various ways. For example, the frame 130 can be fixed to the mouse 120 by means of adhesive applied onto each of the four posts 131. The surface 111 may be a diffuse surface, for example with a roughness of grade VDI33, which works best for most kinds of optical mice. A larger size of the surface 111 is advantageous because it allows a longer lateral movement of the board 110 with respect to the window 210.

Two lifting members 120 may be provided on the board 110 to function similarly to those arranged on the frame 130, namely, to remain the distance between the frame 130 and the board 110 minimized. However, the number, arrangement and size of the lifting member 120 are not to be limited, which will be explained in detail.

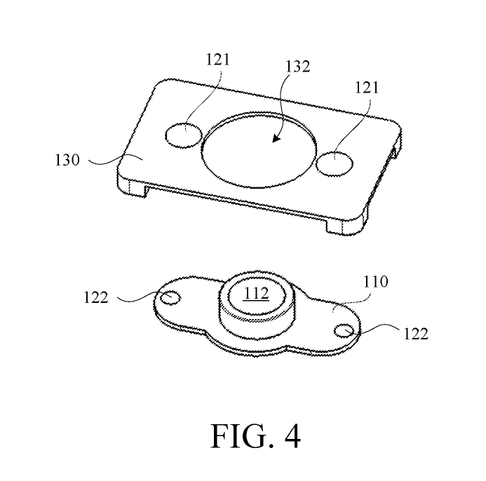

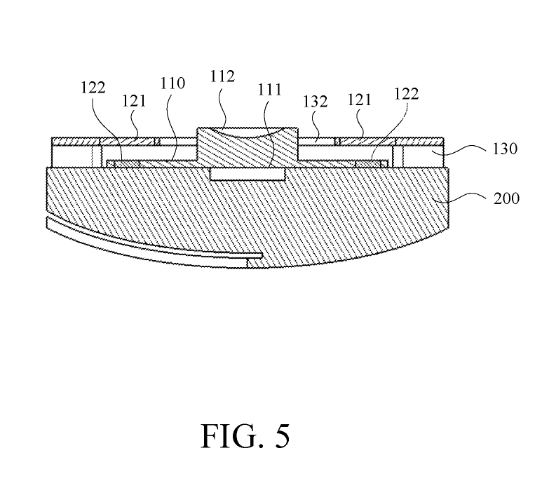

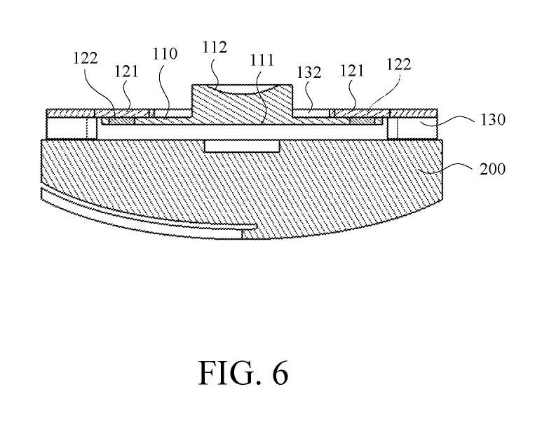

FIG. 4 shows an exploded view of the apparatus 100, FIG. 5 shows a sectional side view of the frame 130 attached to the mouse 200 with the board 110 placed against the window 210, and FIG. 6 shows a sectional side view of the frame 130 attached to the mouse 200 with the board 110 placed away from the window 210.

The frame 130 along with the board 110 may include two pairs of frame aligning portion 121 on the frame 130 and board aligning portion 122 on the board 110. One of the frame aligning portions 121 may be used to attract one of the board aligning portions 122, while the other one of the frame aligning portions 121 may be used to attract the rest one of the board aligning portions 122.

An opening 132 may be provided on the frame 130 so as to allow the protrusion 112 passing through in case that the board 110 is in contact with the frame 130, as shown in FIG. 6. However, as shown in FIG. 5, the protrusion 112 may also pass through the opening 132 in case that the surface 111 is in contact with the window 210. Top surface of the protrusion 112 may be formed in a curve so as to allow a better feeling when moving the board 110 by a finger with respect to the frame 130 or the mouse 200.

In one embodiment, for each pair of the frame aligning portion 121 and the board aligning portion 122, one of the frame aligning portion 121 and the board aligning portion 122 is formed of a ferromagnetic material, while the other one is a magnet. For example, as shown in FIG. 4, the left frame aligning portion 121 may be a magnet and then the left board aligning portion 122 is formed of a ferromagnetic material. On the other hand, the right frame aligning portion 121 may be formed of a ferromagnetic material and then the right board aligning portion 122 is a magnet.

In another embodiment, the frame aligning portion 121 and the board aligning portion 122 are both magnets. For example, as shown in FIG. 4, the left frame aligning portion 121 and the left board aligning portion 122 are each magnets. The polarity of these two magnets is arranged in such a way that the left board aligning portion 122 and the left frame aligning portion 121 are attracted to one another. Likewise, the right frame aligning portion 121 may be a magnet and then the right board aligning portion 122 is also a magnet by arranging its polarity so as to be attracted by the magnet for the right frame aligning portion 121.

In one embodiment, for each pair of the frame aligning portion 121 and the board aligning portion 122, the former has a larger size compared with the latter. By this configuration, the board aligning portion 122 is easily attracted by the frame aligning portion 121 even if the board 110 is rotated for a certain degrees so that the board aligning portion 122 is not aligned with the frame aligning portion 121. This allows for additional tolerance when operating the board 110 back and forth between the frame 130 and the window 210.

In another embodiment, the lifting member 120 includes an elastic member (not shown) that connects the board 110 to the frame 130. Such an elastic member may be selected from a rubber band, a spring and the like. If a force applied onto the board 110 or the protrusion 112 is smaller than a predefined threshold, the elastic member will force the board 110 to move toward the opening 132 and eventually be in contact with the frame 130. If a force large enough is applied onto the board 110 or the protrusion 112, the board 110 will move toward the window 210 until it is in contact with the window 210.

In one embodiment, the lifting member 120 is adapted to position the protrusion 112 at the center of the opening 132 if the board 110 is attracted to the frame 130. This can be achieved by the placement of the frame aligning portion(s) 121 and the board aligning portion(s) 122, or by the provision of the elastic member as described above.

The operation of the apparatus 100 can be described with reference to FIGS. 5, 6 and 7. Reference is first made to FIG. 6, the board 110 is lifted and placed in contact with the frame 130 (the frame aligning portion(s) 121 and the board aligning portion(s) 122 are attracted together). At this point, the lateral movement of the board 110 will not navigate the mouse 200 and thus will not move the cursor within the screen. Because of the lifting members 120 (the frame aligning portion(s) 121 and the board aligning portion(s) 122, or the elastic member), the protrusion 112 can be placed at the center of the opening 132, which allows for an initial position of the operation to start with.

If the user wants to navigate the mouse 200, he/she needs to push the board 110 toward the window 210 so that the surface 111 is in contact with the window 210, as shown in FIG. 5. In this case, the lateral movement of the board 110 is detectable by the optical mouse 200 and the user is therefore able to control the cursor intentionally if the surface 111 is laid against the window 210.

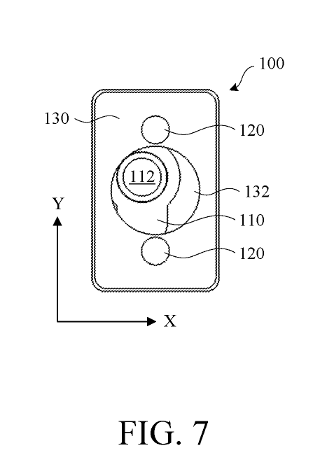

Because of the size limitation of the opening 132, when the board 110 is laterally moved for a certain distance, the protrusion 112 will collide with the edge of the opening 132, as shown in FIG. 7. As a result, the cursor cannot be moved anymore. In FIG. 7, an X-Y coordinate system illustrates that the lateral movement of the board 110 is constrained within the X-Y plane only. In this regard, the user may lift the board 110 away from the window 210, such that the distance between the surface 111 and the window 210 exceeds the predefined threshold. It would be appreciated that the existence of the lifting member(s) 120 makes it possible to reposition the protrusion 112 back to the center of the opening 132 automatically, as shown in FIG. 6. In this way, the user is able to control the cursor and move it anywhere in the screen.

It is to be understood that scopes of the subject matter described herein are not limited to the number, shape, size, arrangement or the like of the lifting member 120 as described in the above example embodiments. For example, in alternative embodiments, the frame aligning portion(s) 121 may be embedded into the frame 130 or attached to the frame 130. Alternatively, or in addition, the board aligning portion(s) 122 may be embedded into the board 110 or attached to the board 110. In addition, the material, size, arrangement of the frame 130 and the board 110 are not to be limited as well.

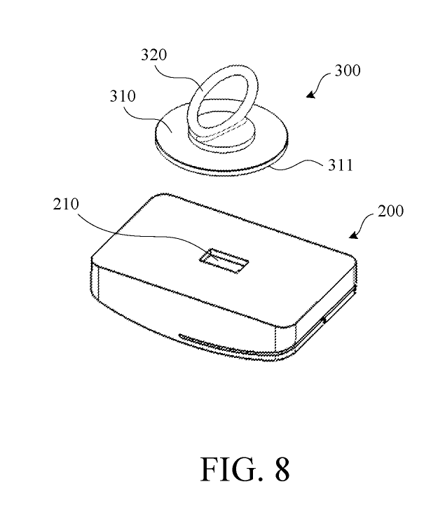

FIG. 8 shows a perspective view of the apparatus 300 displaced from the mouse 200 according to another embodiment of the subject matter described herein. The lifting member may be in a form of a ring 320 located on a side of the board opposite to a surface 311 used to be laid against the window 210 of the mouse 200. The ring 320 is capable of facilitating the lateral movement of the surface 311 or the board 310 with respect to the window 210 and the vertical movement of the surface 311 or the board 310. The surface 311 can be diffusive so as to be used with most of mice commercially available.

If the user wants to use the apparatus 300, he/she may put the ring 320 onto one of his/her finger, so as to navigate the mouse 200 held by a same hand. If the surface 311 moves beyond the window 210, the user may lift the board 310 manually and place the surface 311 back to the window 210 for further control of the cursor.

Correlation between the lateral movement of the board with respect to the window of the mouse and the movement of the cursor can be defined by software or firmware. In some embodiments, the user is enabled to set a corresponding profile (the way he/she likes to use the apparatus according to the embodiments of the subject matter described herein) before he/she uses the apparatus with an optical mouse.

The apparatus in accordance with the embodiments of the subject matter described herein provides a simple yet effective structure to navigate an optical mouse in the air, as described above. The universality of the apparatus allows it to be used with most of optical mice on the market. As a result, the relatively simple structure of the apparatus results in a cost effective manufacturing and easy assembly.

The above examples are described only for the purpose of illustration, without suggesting any limitations as to the scope of the subject matter described herein. Any additional or alternative materials can be used to make the components of the switch.

It is to be understood that “top”, “bottom”, “front”, “rear”, “side”, “lateral” and the like are only used to describe the relationship between the components in the figures, instead of limiting their orientation or positioning. For example, in FIG. 2, the apparatus 100 can be seen as being placed above the mouse 200, and can also be seen as being placed underneath the mouse 200.

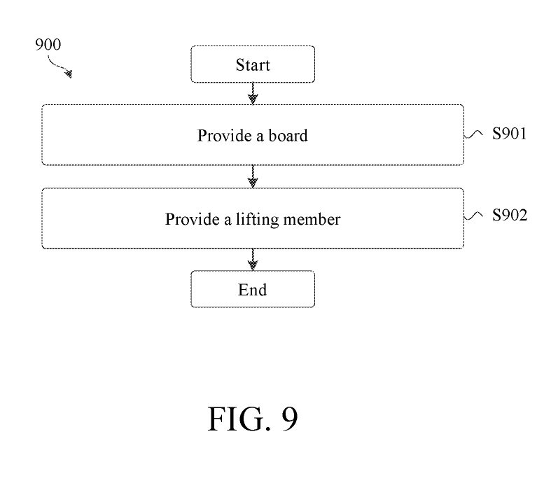

With reference to FIG. 9, it illustrates a block diagram of a method 900 of manufacturing the apparatus in accordance with embodiments of the subject matter described herein. The method 900 is entered at step S901, where a board is provided. The board has a surface operable to be in contact with a window of the optical mouse.

At step S902, a lifting member operable to move the surface away from the window is provided. In response to a distance between the surface and the window being below a predefined threshold, a lateral movement of the surface with respect to the window being detectable by the optical mouse. In response to the distance between the surface and the window exceeding the predefined threshold, the lateral movement of the surface with respect to the window being undetectable by the optical mouse.

In one embodiment, the method may further include providing a frame attachable to the optical mouse, the lifting member attracting the board to the frame in response to a force applied on the board toward the optical mouse being below a predefined threshold.

In a further embodiment, the method may further include providing on the lifting member a frame aligning portion on the frame and a board aligning portion on the board, the board aligning portion being attractable to the frame aligning portion.

In yet a further embodiment, the method may further include providing one of the frame aligning portion and the board aligning portion made of a ferromagnetic material, and providing the other one of the frame aligning portion and the board aligning portion to include a magnet.

Additionally or alternatively, the method may include providing each of the frame aligning portion and the board aligning portion to include a magnet.

In a further embodiment, the frame aligning portion has a larger size compared with the board aligning portion.

In yet another embodiment, the method may further include providing on the lifting member an elastic member operable to connect the board to the frame.

In still another embodiment, the method may further include providing an opening on the frame; and providing, on the board, a protrusion passing through the opening if the board is in contact with the frame, the lifting member positioning the protrusion at the center of the opening if the board is attracted to the frame.

In another embodiment, the method may further include providing the lifting member in the form of a ring located on a side of the board opposite to the surface, the ring facilitating a manual movement of the surface with respect to the window.

While operations are depicted in a particular order in the above descriptions, this should not be understood as requiring that such operations be performed in the particular order shown or in sequential order, or that all illustrated operations be performed, to achieve desirable results. In certain circumstances, multitasking and parallel processing may be advantageous. Likewise, while several details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An apparatus for use with an optical mouse, comprising:
a board having a surface operable to be in contact with a window of the optical mouse; and
a lifting member operable to move the surface away from the window, in response to a distance between the surface and the window being below a predefined threshold, a lateral movement of the surface with respect to the window being detectable by the optical mouse, and
in response to the distance between the surface and the window exceeding the predefined threshold, the lateral movement of the surface with respect to the window being undetectable by the optical mouse.

2. The apparatus according to claim 1, further comprising:
a frame attachable to the optical mouse, the lifting member attracting the board to the frame in response to a force applied on the board toward the optical mouse being below a predefined threshold.

3. The apparatus according to claim 2, wherein the lifting member comprises:
a frame aligning portion on the frame; and
a board aligning portion on the board, the board aligning portion being attractable to the frame aligning portion.

4. The apparatus according to claim 3, wherein one of the frame aligning portion and the board aligning portion is made of a ferromagnetic material and the other of the frame aligning portion and the board aligning portion includes a magnet.

5. The apparatus according to claim 3, wherein each of the frame aligning portion and the board aligning portion includes a magnet.

6. The apparatus according to claim 5, wherein the frame aligning portion has a larger size than the board aligning portion.

7. The apparatus according to claim 2, wherein the lifting member comprises an elastic member operable to connect the board to the frame.

8. The apparatus according to claim 2, wherein the frame comprises an opening, wherein the board comprises a protrusion passing through the opening if the board is in contact with the frame, the lifting member positioning the protrusion at the center of the opening if the board is attracted to the frame.

9. The apparatus according to claim 1, wherein the lifting member is in the form of a ring located on a side of the board opposite to the surface, the ring facilitating a manual movement of the surface with respect to the window.

10. The apparatus according to claim 1, wherein the surface is diffusive.

11. An apparatus for use with an optical mouse, comprising:
a frame operable to form a detachable attachment to the optical mouse, the frame comprising:
an opening; and
a frame aligning portion located in the vicinity of the opening; and
a board having a surface operable to be in contact with a window of the optical mouse, the board comprising:
a board aligning portion attractable to the frame aligning portion,
the board being operable through the opening, in response to a distance between the surface and the window being below a predefined threshold, a lateral movement of the surface with respect to the window being detectable by the optical mouse, and
in response to the board aligning portion being attracted to the frame aligning portion, the lateral movement of the surface with respect to the window being undetectable by the optical mouse.

12. The apparatus according to claim 11, wherein the frame aligning portion has a larger size than the board aligning portion.

13. The apparatus according to claim 11, wherein at least one of the frame aligning portion and the board aligning portion includes a magnet.

14. The apparatus according to claim 11, wherein the board comprises a protrusion passing through the opening if the board is in contact with the frame, the frame aligning portion and the board aligning portion positioning the protrusion at the center of the opening if the board is attracted to the frame.

15. A method of manufacturing an apparatus for use with an optical mouse, comprising:
providing a board, the board having a surface operable to be in contact with a window of the optical mouse; and
providing a lifting member operable to move the surface away from the window,
in response to a distance between the surface and the window being below a predefined threshold, a lateral movement of the surface with respect to the window being detectable by the optical mouse, and
in response to the distance between the surface and the window exceeding the predefined threshold, the lateral movement of the surface with respect to the window being undetectable by the optical mouse.

16. The method according to claim 15, further comprising:
providing a frame attachable to the optical mouse, the lifting member attracting the board to the frame in response to a force applied on the board toward the optical mouse being below a predefined threshold.

17. The method according to claim 16, further comprising:
providing on the lifting member a frame aligning portion on the frame and a board aligning portion on the board, the board aligning portion being attractable to the frame aligning portion.

18. The method according to claim 17, further comprising:
providing one of the frame aligning portion and the board aligning portion to include a magnet.

19. The method according to claim 16, further comprising:
providing an opening on the frame; and
providing, on the board, a protrusion passing through the opening if the board is in contact with the frame, the lifting member positioning the protrusion at the center of the opening if the board is attracted to the frame.

20. The method according to claim 15, further comprising:
providing the lifting member in the form of a ring located on a side of the board opposite to the surface, the ring facilitating a manual movement of the surface with respect to the window.
